(19) United States
(12) Patent Application Publication
(10) Pub. No.: US 2023/0056553 A1
(43) Pub. Date: Feb. 23, 2023

(54) Amidoxime Functionalized Polymers Loaded with Alkyl Amines, Methods of Making, And CO2 Capture Using Same

(71) Applicant: Battelle Memorial Institute, Columbus, OH (US)

(72) Inventors: David Hopkinson, Columbus, OH (US); Ali Sekizkardes, McDonald, PA (US); James Hoffman, South Park, PA (US); Shouliang Yi, Columbus, OH (US); Victor Kusuma, Columbus, OH (US)

(21) Appl. No.: 17/891,153

(22) Filed: Aug. 19, 2022

Related U.S. Application Data
(60) Provisional application No. 63/234,974, filed on Aug. 19, 2021.

(51) Int. Cl. B01J 20/26; B01J 20/28; B01J 20/30; C10L 3/10; H01M 10/52; B01D 53/04

(52) U.S. Cl. CPC B01J 20/265; B01D 53/04; B01J 20/3085; B01J 20/28004; B01J 20/28016; B01J 20/28023; C10L 3/104; H01M 10/52; B01D 2253/202; B01D 2253/304; B01D 2256/10; B01D 2256/24; B01D 2257/504; C10L 2290/542; H01M 2300/0091

(57) ABSTRACT

A novel adsorbent and contactor material based on polymer functionalized with amidoxime and alkylamines moieties. Methods of making the material are also described. The material can be easily processed into any desired sorbent geometry such as solid fibers, electrospun fibers, hollow fibers, monoliths, etc. The adsorbent exhibits a very high affinity toward acidic gases such CO₂ and can be used in direct air capture, power plant-based CO₂ capture, and industrial CO₂ capture applications. The material can also serve as a contactor that accommodates other adsorbents within its structure.

### RELATED APPLICATIONS

This application claims the priority benefit of U.S. Provisional Pat. Application Ser. No. 63/234,974 filed 19 Aug. 2021.

### Introduction

The main problems associated with sorbents used in CO₂ capture include: high-cost and complex material design and preparation; low surface area and porosity; low CO₂ uptake and CO₂/N2 selectivity properties of polymeric sorbents; slow kinetics because of long adsorption -desorption cycles and low heat transfer; low material stability, humidity stability, contaminant (SOx and NOx) stability pore stability and amine leaching from the sorbent.

### SUMMARY OF THE INVENTION

The invention provides a new synthesis and a new sorbent material. The invention includes CO₂ capture applications including post-combustion flue gas from coal and natural gas based power plants, direct air capture, natural gas purification and biogas upgrading. The novel design of the sorbent consists of two main components: (i) amidoxime functionalized polymer and (ii) alkylamine. This invention not only discloses the first example of the combination of amidoxime-based sorbent material with alkyl amines, but also provides a detailed experimental route to create a library of potential sorbent formulations based on the target application. With this route, the concentration of amidoxime functional groups can be controlled and sorbents can be incorporated with many types of amines.

In one aspect, the invention provides a sorbent material (also called simply a sorbent), comprising: a polymer comprising an amidoxime moiety; and an alkyl amine disposed on a surface of the polymer.

In sorbent in any aspects of the invention can be further characterized by one or any combination of the following: wherein the amidoxime moiety is covalently bonded to the polymer (this can be represented by the chemical formula R¹C(═N(OH))NR²R³, where R¹ is a monomer moiety and the R¹C(═N(OH))NR²R³ unit repeats in the polymer); wherein the polymer is a microporous polymer and comprising the alkyl amine disposed on surfaces within pores in the polymer; further comprising sorbent fillers (examples known classes of sorbent fillers include: porous silica, porous carbon, porous cage materials, metal organic frameworks, porous organic polymers, and combinations thereof); porous cage materials may include, for example, compounds such as cyclodextrins; where the sorbent is characterizable by an IR spectrum with a broad peak around 3300-3600 and peaks within ±3 wavenumbers of 2240 and 1604 cm⁻¹; where the sorbent is in the form of fibers such as solid fibers, hollow fibers, or electrospun fibers; where the sorbent is in the form of a powder; where the sorbent is in the form of a solid continuous structure having a dimension in at least one direction of at least 1 cm, or at least 5 cm (for example, the sorbent may be in the form of a honeycomb); where CO₂ is sorbed into the sorbent material, such as comprising at least 3 wt% or at least 5 wt%, or from 5 to 15 wt% CO₂; where the sorbent is characterizable by a CO₂ uptake of at least 30 (or at least 35) cm³/g sorbent at 400 mbar CO₂ (or at 200 mbar CO₂) at 298 K; where the sorbent is characterizable by a CO₂ uptake of 30 ±30% (i.e., 21 to 39) cm³/g sorbent at 400 mbar CO₂ at 298 K (generally, any of the inventive compositions or methods can be characterized by ±30% or ±20% or ±10% of any of the spectroscopic or other physical characteristics (such as CO₂/N2 selectivity or CO₂ uptake (based on any of the data points in FIG. 2A), or cycle behavior, or heat of adsorption) disclosed herein); and/or where the sorbent comprises the repeating unit R¹C(═N(OH))NR²R³, where R¹ is a monomer, R² is H, CH₃, or CH₂CH₃, and R³ is H, CH₃, or CH₂CH₃.

In another aspect, the invention provides a method of sorbing a molecular species, comprising: contacting the sorbent material with a fluid composition comprising the molecular species at a first set of conditions wherein at least a portion of the molecular species in the fluid composition is adsorbed by the sorbent material at the first set of conditions to form the sorbent material with sorbed molecular species. The molecular species can be an atom, molecule, ion, or a chemical moiety. Typically, the fluid composition comprises a plurality of different molecular species and one or more types of molecular species are preferentially sorbed by the sorbent material. In preferred embodiments of the invention, the fluid composition is a gas (typically comprising N2) and the molecular species is carbon dioxide. A “chemical moiety” is a defined part of a larger species, for example, a carboxylate group.

The method can be further characterized by one or any combination of the following: exposing the sorbent material with sorbed component to a second set of conditions; wherein the first set of conditions comprise a first temperature and a first pressure and the second set of conditions comprise a second temperature and second pressure; wherein at least one of the second temperature and second pressure are different than at least one of the second temperature and second pressure; and wherein at least a portion of the molecular species is desorbed from the sorbent at the second set of conditions; wherein the fluid composition comprises CO₂ and N2 and the sorbent material has a CO₂/N2 selectivity of at least 100, preferably at least 500 or in the range of 200 to 1000; wherein the method is used to capture CO₂ or other acidic gas from a power plant direct air capture facility, or a steel or cement manufacturing facility; wherein the method is used to removed CO₂ from a combustion stream; where the method is used to remove CO₂ from natural gas or other hydrocarbon-containing gas; wherein the molecular species comprises: a rare earth element; a precious metal element; or a toxic metal element; where the method comprises membrane based gas and liquid separation; or gas storage; solid state energy storage; catalysis or gas sensing; where the method comprises solid state energy storage or catalysis (for example, the material can be incorporated in the electrolyte sections of batteries, or engineered into a catalyst to convert CO₂ into carbon products).

In another aspect, the invention provides a method of making a sorbent material, comprising: reacting a polymer having a R¹—C≡N (cyano) moiety with HONR²R³ to form a polymer with an amidoxime moiety and reacting the polymer with an amidoxime moiety with an alkyl amine. Preferably, the step of reacting a polymer having a R¹—C≡N (cyano) moiety with HONR²R³ is conducted in the presence of a nonsolvent such as methanol.

### BRIEF DESCRIPTION OF THE DRAWINGS

FIG. 1. Reaction scheme of PIM-1-AO-DETA synthesized by PIM-1 and DETA.

FIG. 2. (A) CO2 adsorption isotherms of PIM-1, PIM-1-AO, PIM-1-AO-DETA and PIM-1-AO-PEI. (B) CO₂ adsorption cyclability test at 0.15 bar and 298 K, desorption at 348 K under vacuum. (C) CO₂ isosteric heats of adsorption for PIM-1, PIM-1-AO, and PIM-1-AO-DETA.

FIG. 3. Fiber sorbents processed from a phase inversion method.

### DETAILED DESCRIPTION OF THE INVENTION

In the general case, the polymer can be any polymer comprising an amidoxime moiety. The amidoxime moiety should be on a surface of the polymer such that the alkyl amine can be attracted to the polymer via hydrogen bonding. Preferred polymers include POPs and PIMs (see below). In some preferred embodiments the polymer has a number average molecular weight in the range of 20 to 150 kg/mol. In some preferred embodiments the polymer has a porosity of at least 10 vol%, or at least 20 vol%, or at least 50 vol%. In some embodiments, the polymer has at least 30 vol% of pores in a size range of 0.6 to 1.2 nm; or at least 50 vol% of pores in a size range of 0.6 to 1.2 nm; or 70 vol% of pores in a size range of 0.6 to 1.2 nm.

Polymer precursors to the inventive sorbent material typically comprise a cyano (CN) group that reacts to form the amidoxime moiety. One preferred PIM can be formed by the reaction of 3,3,3',3'-tetramethyl-1,1'-spirobisindane-5,5',6,6'-tetrol (TTSBI) and 1,3-dicyanotetrafluorobenzene (DCTB).

Porous sorbents are one class of material being studied for use in carbon dioxide (CO2) capture applications. In the last decade, a new class of porous materials, porous organic polymers (POPs) have emerged, including porous aromatic frameworks (PAFs), porous polymeric networks (PPNs), benzimidazole linked polymers (BILPs) and hyper crosslinked polymers (HPCs). In general, POPs have been reported as high surface area materials with a highly stable polymer structure resulting from the covalent bonding between the monomers. However, the CO₂ uptake capacity of most POPs is not able to exceed twenty (20) cubic centimeters per gram (cc/g) (at 0.15 bar CO₂ and 298 Kelvin (K)), as the interaction between CO₂ and POPs is primarily due to physisorption. Although there have been several efforts to append primary amines to POPs through either amine-impregnation or grafting methods, drawbacks such as harsh synthesis, poor scalability, and poor processability have been a hurdle for POPs as a breakthrough for CO₂ capture.

Polymers with intrinsic microporosity (PIMs) are POPs that can be synthesized inexpensively and under mild reaction conditions. In contrast to most POPs, PIMs can be processed into thin films and fibers. Consequently, studies on PIMs have focused on gas separation membrane applications in which they feature exceptionally high permeability and moderate selectivity for several different light gas pairs. Although PIM-based membranes have been among the best performing gas separation materials, little is known about PIMs as solid sorbents for CO₂ capture or other gas separations. While PIMs possess the high surface area and permanent microporosity desired for a sorbent, they also suffer from low CO2 adsorption capacity (less than 10 cc/g at 0.15 bar and 298 K) due to relatively large (greater than 1 nm) non-polar micropores as well as some mesopores.

The amidoxime moiety has the formula —C(═N(OH))NR²R³. R² and R³ can be the same or different and are selected from H, alkyls or substituted alkyls (including alkenes or alkynes); preferably methyl, ethyl, propyl or butyl; most preferably R² and R³ are H. The hydroxyl hydrogen may be shared with an amino group on the alkyl amine.

The alkyl amine comprises an amine (-NHR) moiety that is part of a larger molecule comprising at least one carbon. Preferably the alkyl amine has a molecular weight of between 31 and 300 daltons, or 31 and 200 daltons. Preferably, the alkyl amine comprises between 2 and 5 amine groups. Examples of alkyl amines include: diethylenetriamine (DETA), tetraethylenepentamine (TEPA), tetraethylenepentamine-acrylonitrile (TEPAN), ethylenediamine, ethylamine, aniline, benzylamine, piperidine, pyrrole, diethanolamine (DEA), monoethanolamine (MEA), triethylenetetramine (TETA), 2-amino-2-methyl-1-propanol (AMP), and 2-(isopropylamino)ethanol (IPAE).

The invention discloses a sorbent functionalized with amidoxime and alkylamines. The invention discloses a unique synthesis protocol which can be applied not only to the utilized polymer (PIM-1), but also a library of other polymers and even other non-polymeric materials to create a new sorbent. The method is cost efficient and scalable.

The invented sorbent can possess very high CO₂ capture performance compared to other polymeric sorbents. To our knowledge, the CO₂ uptake capacity is the highest ever recorded in any PIM based porous polymeric sorbent and amidoxime functionalized sorbents (polymers and others). The invented sorbent can be processed into any sorbent geometries including fiber, monolith, flat sheet, pellets, etc.

Amidoxime functionalization can be incorporated into a wide variety of polymer types. The amidoxime functionality, surface area and pore size properties can be easily adjusted for CO2 sorption and other applications. Other applications of the sorption media include: rare earth elements capture; precious and/or toxic metal capture; membrane based gas and liquid separation; gas storage; solid state energy storage; and gas sensor applications. The invention includes use of the sorbent material in any of these applications.

The sorbent or sorbent precursor is processible in a molten or dissolved state. The sorbent can be converted into several sorbent geometries such as fibers (FIG. 3). A difference between this invention and prior best performing sorbents such as zeolites, silica and MOFs is the advantage of not having a need for an additional processing material (polymers, etc.) in the system. The inventive sorbent is preferably soluble in organic solvents including DMF, NMP, DMSO and DMAc. In the sorbent literature, it has been increasingly suggested that the fiber form of the sorbents can decrease the carbon capture cost significantly as the pressure drop problem is less encountered in the fiber forms compared to powder sorbents. The maximum sorbent loading is usually below 50 wt% (of the actual sorbent), so the CO₂ uptake performance is curbed by at least 50% as the processing materials are mostly a non-sorbent. This invention offers a solution to this challenge by creating a processible sorbent material that consists chiefly (>50 mass%) or entirely of the sorbent material. In preferred embodiments of the invention, the sorbent material comprises 10 wt% or less, or 5 wt% or less, of polymers other than the functionalized polymer. In other embodiments, the sorbent material can be combined with a material such as polyphosphazene.

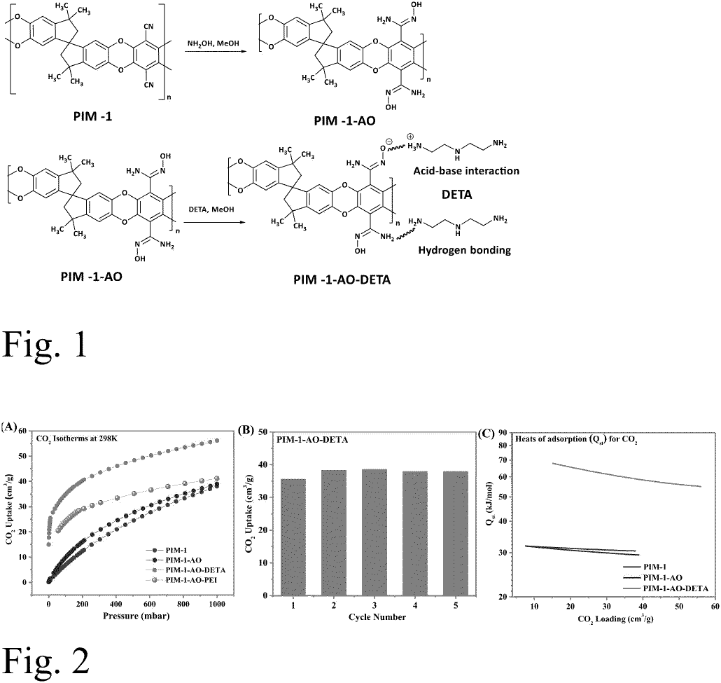

The synthesis comprises a three-step sorbent preparation method (FIG. 1). In the first step, the CN-functionalized polymer is provided or synthesized. In the second step, the polymer is functionalized with amidoxime groups by using a hydroxylamine reagent. This step can be effected using a low-temperature reaction method and low cost reagents. The use of a nonsolvent (methanol) in the reaction is important in this second step as the nucleophilic attack of the hydroxylamine reagent can be controlled. The controlled reaction provides precise adjustability over the amidoxime functionalities. In the third step, the amidoxime functionalized polymer (such as PIM-1-AO) is treated with alkylamines such as DETA. The proposed sorbent preparation method provides a scalable and cost-efficient material synthesis.

The invention is designed on the effective use of amidoxime groups in a sorbent media. The amidoxime groups can strongly interact with the host amine molecules. The strong interaction between the amidoxime and amine groups immobilizes the amine molecules within the sorbent, thus the major problems associated with amine based sorbent can be eliminated. For example; amine leaching, which is often encountered with sorbents, is limited in this invention given the unique design of the sorbent. Another attribute of the use of amidoxime in the sorbent is enabling molecular amine utilization which offers great sorbent attributes such as fast kinetics and low temperature CO₂. Most of the amine based sorbents depend on polymeric amines such as polyethylenimine (PEI). These polymeric amines provide high CO₂ uptake capacity. However, the amines also bring deficiencies to the impregnating sorbent including worsen mass and heat transfer character. CO₂ transport (adsorption and desorption) in bulk polymeric amines is relatively slow. Our sorbent design provides molecular amines in the sorbent which can interact strongly with amidoxime functional groups.

The invention is experimentally proven and characterized by common sorbent instruments including surface area analyzer, FT-IR, TGA and elemental analysis. The chemical structure was confirmed by IR absorption for —OH, nitrile, and N—H with a broad peak around 3300-3600 and peaks at 2240, 1604 cm-1, respectively. The amine content in the sorbent was quantified by TGA and elemental analysis. The amine presence in the sorbent was also evinced by CO₂ adsorption and desorption isotherms. Accordingly, a large hysteresis, observed between the isotherms, addresses the chemisorption nature of the sorbent due to the incorporated alkylamines. Typically, the amine content in the characterized sorbents is below 15 wt%, which is drastically lower than the usual amine (40-80 wt%) reported in sorbents. The low amine content contributes to the desired sorbent properties such as fast kinetics and low cost sorbent regeneration.

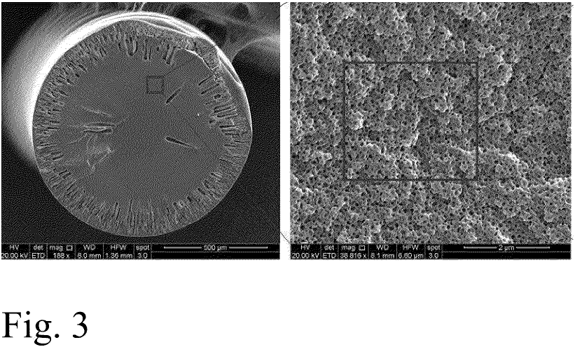

The invention was tested with two different (commercial) gas adsorption analyzers. Very high CO2 uptake performance (10 wt% CO₂ at 0.15 bar and 298 K) was recorded (FIG. 2A). Moreover, the CO2 uptake capacity was cyclable after several regeneration steps (FIG. 2B). The CO2/N2 selectivity was found to be also very high (>500). The heats of adsorption for CO₂ were calculated from the CO₂ isotherms and the results revealed that the sorbent is a chemisorbent (FIG. 2C).

1. A sorbent material, comprising:
a polymer comprising an amidoxime moiety; and
an alkyl amine disposed on a surface of the polymer.

2. The sorbent of claim 1 wherein the amidoxime moiety is covalently bonded to the polymer. This can be represented by the chemical formula R¹C(═N(OH))NR²R³, where R¹ is a monomer moiety and the R¹C(═N(OH))NR²R³ unit repeats in the polymer.

3. The sorbent of any of the above claims wherein the polymer is a microporous polymer and comprising the alkyl amine disposed on surfaces within pores in the polymer.

4. The sorbent of any of the above claims comprising sorbent fillers.

5. The sorbent of claim 4 wherein the sorbent fillers are selected from: porous silica, porous carbon, porous cage materials, metal organic frameworks, porous organic polymers, and combinations thereof. These are classes of known sorbent materials; porous cage materials may include, for example, compounds such as cyclodextrins.

6. The sorbent of any of the above claims characterizable by an IR spectrum with a broad peak around 3300-3600 and peaks within ±3 wavenumbers of 2240 and 1604 cm⁻¹.

7. The sorbent of any of the above claims in the form of fibers.

8. The sorbent of claim 7 where the fibers comprise solid fibers, hollow fibers, or electrospun fibers.

9. The sorbent of any of the above claims in the form of a powder.

10. The sorbent of any of claims 1 - 8 in the form of a solid continuous structure having a dimension in at least one direction of at least 1 cm, or at least 5 cm.

any of the above claims comprising at least 3 wt% or at least 5 wt%, or from 5 to 15 wt% CO₂.

12. The sorbent of any of the above claims characterizable by a CO₂ uptake of at least 30 cm³/g sorbent at 400 mbar CO₂ at 298 K.

13. The sorbent of any of the above claims characterizable by a CO₂ uptake of 30 ±30% (i.e., 21 to 39 \) cm³/g sorbent at 400 mbar CO₂ at 298 K.

14. The sorbent of any of the above claims comprising the repeating unit R¹C(═N(OH))NR²R³, where R¹ is a monomer, R² is H, CH₃, or CH₂CH₃, and R³ is H, CH₃, or CH₂CH₃.

15. The sorbent of claim 14 wherein R² is H, and R³ is H.

16. A method of sorbing a molecular species, comprising:
contacting the sorbent material of any of the above claims with a fluid composition comprising the molecular species at a first set of conditions wherein at least a portion of the molecular species in the fluid composition is adsorbed by the sorbent material at the first set of conditions to form the sorbent material with sorbed molecular species.

17. The method of claim 16 further comprising exposing the sorbent material with sorbed component to a second set of conditions;
wherein the first set of conditions comprise a first temperature and a first pressure and the second set of conditions comprise a second temperature and second pressure;
wherein at least one of the second temperature and second pressure are different than at least one of the second temperature and second pressure; and
wherein at least a portion of the molecular species is desorbed from the sorbent at the second set of conditions.

18. The method of any of claims 16 - 17 wherein the fluid composition comprises CO₂ and N₂ and the sorbent material has a CO₂/N₂ selectivity of at least 100, preferably at least 500 or in the range of 200 to 1000.

19-24. (canceled)

25. A method of making a sorbent material, comprising:
reacting a polymer having a R¹—C═N (cyano) moiety with HONR²R³ to form a polymer with an amidoxime moiety and reacting the polymer with an amidoxime moiety with an alkyl amine.

26. (canceled)
